(19) United States
(12) Patent Application Publication
(10) Pub. No.: US 2002/0172137 A1
(43) Pub. Date: Nov. 21, 2002

(54) Apparatus for controlling optical pickup and optical writing and reading apparatus having the same

(75) Inventor: Bong-Girl Min, Suwon-si (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/084,351

(22) Filed: Feb. 28, 2002

Related U.S. Application Data
(63) Continuation-in-part of application No. 09/732,181, filed on Dec. 6, 2000.
(60) Provisional application No. 60/314,580, filed on Aug. 23, 2001.
(60) Provisional application No. 60/337,504, filed on Dec. 6, 2001.

(30) Foreign Application Priority Data
Dec. 7, 2001 (KR) 2001-77451

(51) Int. Cl. G11B 17/00; G11B 21/16

(52) U.S. Cl. 369/249

(57) ABSTRACT

An apparatus for controlling an optical pickup and an optical writing and reading apparatus having the same are disclosed. A main shaft and a sub shaft, on which an optical pickup for writing and reading information is movably mounted, are raised and lowered at opposite ends of the shafts by adjusters. The adjusters each comprise a casing fixed to four corners of a deck base and having an inner space and a side gate into which an end of the main and sub shafts is inserted, a spring disposed between the casing and the end of the main and sub shafts to bias the end downward, a base plate attached to a lower surface of the casing, and an adjustable screw tightened to the base plate to move the end of the main and sub shafts upward.

### BACKGROUND OF THE INVENTION

1. Field of the Invention

The present invention relates to an optical writing and reading apparatus, and more particularly to an apparatus for controlling an optical pickup which is intended to control a height as well as a tilt of an optical pickup by detecting deformation of an optical disc being rotated, and an optical writing and reading apparatus having the same.

2. Description of the Prior Art

In general, an optical writing and reading apparatus serves to write and/or read a certain information to and from a disc using an optical system.

In such an optical writing and reading apparatus, an optical disc is seated on a turntable by means of a disc loading unit, and rotated at a predetermined speed by a spindle motor. During rotation of the optical disc, an optical pickup irradiates a laser beam to the disc to write information or read optical signals while radially moving on the optical disc.

At this point, a laser beam, i.e., an optical axis, which is irradiated from the optical pickup, must be maintained to be perpendicular to a surface of the disc, and the optical pickup must be moved while maintaining a parallel position and a certain distance from the surface of the optical disc. If the optical pickup cannot maintain the parallel position and certain distance from the surface of the optical disc owing to warping or fabrication error of the optical disc and the like, there occurs a serious condition that it is impossible to write and read information to and from the disc.

Consequently, an optical writing and reading apparatus is provided with a device for adjusting a tilt of an optical pickup so as to maintain the parallel position with respect to an optical disc.

A conventional optical writing and reading apparatus which is provided with an apparatus for controlling a tilt of an optical pickup is disclosed in Korean Patent Laid-Open Publication No. 2000-72922.

As shown in FIG. 5 depicting the apparatus of the above Korean Patent, a spindle motor 2 is mounted on a deck base 1. The shaft of the motor 2 is coupled to a turntable 3 on which an optical disc is disposed. An optical pickup 4 is positioned to lie across an opening 1a, and is movably connected at its opposite ends to a pair of guide shafts 5 and 5′ disposed at both sides of the deck base 1.

One guide shaft 5 of the pair of guide shafts 5 and 5′ is supported at its opposite ends to the deck base 1 via cylindrical holders 8 and 8′, each of which has an annular threaded groove 8a. The other guide shaft 5′ is supported at its end to the deck base 1 via a locking bracket 9, and at the other end to the deck base 1 via a cylindrical holder 8″ having an annular threaded groove 8a. That is, because the opposite ends of the pair of guide shaft 5 and 5′ are received in the annular threaded grooves 8a of the cylindrical holder 8, 8′ and 8″, the guide shafts are moved upwardly and downwardly by rotation of the cylindrical holders.

However, though such type of conventional optical writing and reading apparatus is capable of maintaining a parallel position of the optical pickup with respect to the optical disc, the apparatus has a disadvantage in that it is impossible to control a distance between the optical pickup and the optical disc.

That is, since a distance between an optical pickup and an optical disc is controlled by the forced fitting manner of the turntable and the spindle motor when the apparatus is fabricated, error in adjusting a distance between an optical pickup and a disc occurs frequently. Such deviation of a distance between an optical pickup and a disc results in a distance variation of an optical system. Consequently, optical efficiency is lowered and error in reading from an optical disc occurs, thereby causing economic by manufacture of faulty products.

Because the above problems will become progressively more serious in proportion to continuous development of high-density optical storage media, prompt solution for these problems is required.

### SUMMARY OF THE INVENTION

Accordingly, the present invention has been made keeping in mind the above problems occurring in the prior art, and an object of the present invention is to provide an apparatus for controlling an optical pickup which is capable of freely controlling not only a tilt (inclination) of an optical pickup but also a distance between an optical pickup and an optical disc.

It is another object of the present invention to provide an optical writing and reading apparatus having the apparatus for controlling an optical pickup.

In order to accomplish the above objects, the present invention provides an apparatus for controlling an optical pickup, comprising adjusters which are adapted to upwardly and downwardly move the each end of the main and sub shafts supported thereto to separately control heights of the ends from a deck base, an optical pickup being mounted at its opposite ends on the main and sub shafts, whereby the parallel position and certain distance between the optical pickup and an optical disc can be maintained by controlling tilts and heights of the main and sub shafts.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a plan view showing a deck base assembly of an optical writing and reading apparatus to which an apparatus for controlling an optical pickup according to the present invention is applied;

FIG. 2 is a bottom view of FIG. 1;

FIG. 3 is a schematic side view of FIG. 1;

FIG. 4 is an exploded perspective view showing an adjuster for supporting an end of a main shaft along which an optical pickup is moved while allowing the end of the main shaft to be raised and lowered; and

FIG. 5 is a perspective view of an optical writing and reading apparatus to which a conventional tilt control apparatus is applied.

### DETAILED DESCRIPTION OF THE INVENTION

This invention will be described in further detail by way of example with reference to the accompanying drawings.

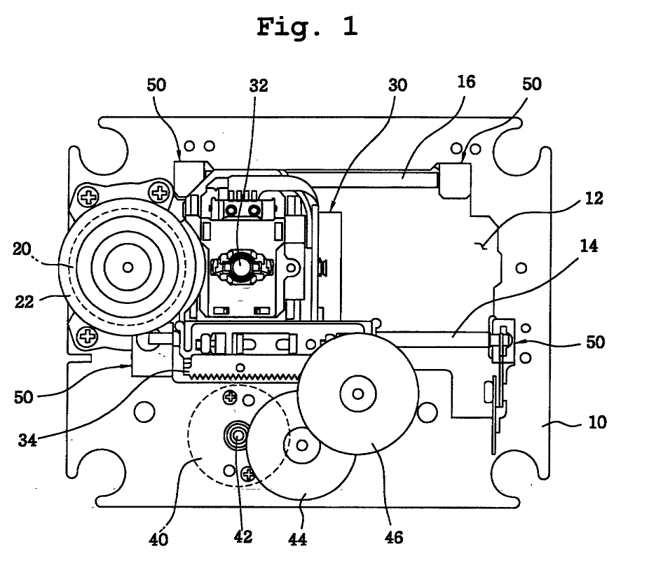

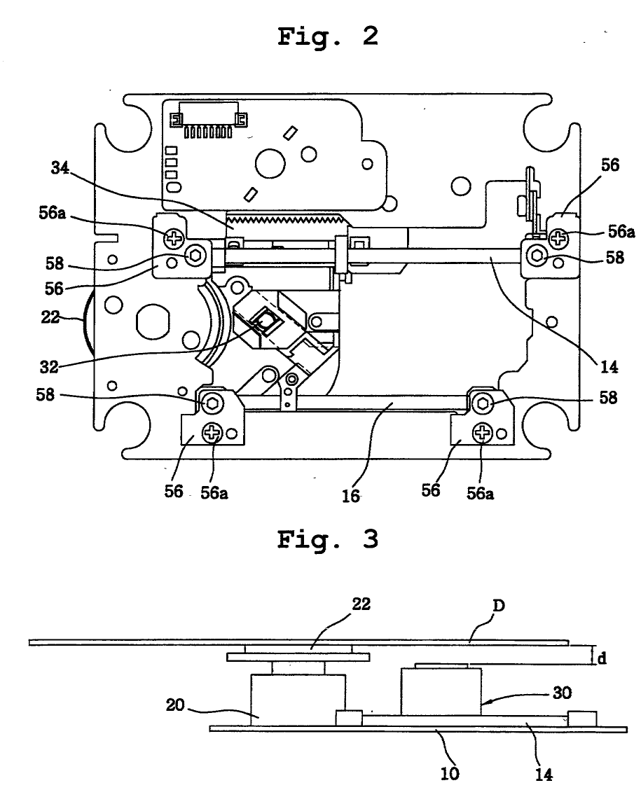

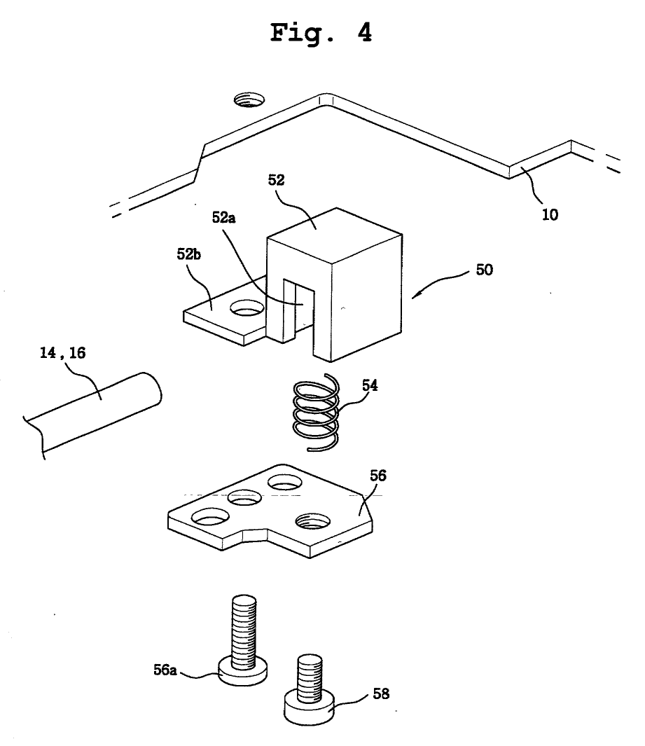

FIG. 1 is a plan view showing a deck base assembly of an optical writing and reading apparatus to which an apparatus for controlling an optical pickup according to the present invention is applied, FIG. 2 is a bottom view of FIG. 1, FIG. 3 is a schematic side view of FIG. 1, and FIG. 4 is an exploded perspective view showing an adjuster for supporting an end of a main shaft along which an optical pickup is moved while allowing the end of the main shaft to be raised and lowered.

As illustrated in the drawings, the deck base 10 is formed at its center portion with an opening 12. A main shaft 14 and a sub shaft 16 are disposed to both sides of the opening 12. The main shaft 14 and the sub shaft 16 are supported at opposite ends thereof by adjusters 50 such that the each end of the main and sub shafts 14 and 16 are capable of being moved upwardly and downwardly.

A turntable 22 adapted to be rotated by a spindle motor 20 is mounted on the deck base 10 such that the turntable 22 is situated next to the opening 12. An optical disc “D” is placed on the turntable 22 to be rotated therewith.

An optical pickup 30 equipped with an object lens 32 is mounted at its opposite ends on the main shaft 14 and the sub shaft 16 such that the optical pickup 30 can be horizontally moved along the main and sub shafts 14 and 16. The horizontal movement of the optical pickup 30 is achieved by a set of gears.

Specifically, a stepping motor 40 is attached to a bottom surface of the deck base 10 such that a shaft of the stepping motor 40 passes upwardly through the deck base 10. A driving gear 42 is coupled to the end of the shaft. Turning force of the driving gear 42 is transmitted to a driven gear 46 through an intermediate gear 44 where the turning force is transmitted to a rack 34 disposed to a side of the optical pickup 30 to cause the rack 34 and thus the optical pickup 30 to be linearly moved along the main shaft 14.

Controls of a tilt (inclination) and a height of the main shaft 14 and the sub shaft 16 are achieved by the adjuster 50.

The adjuster 50 comprises a casing 52, a spring 54 received in the casing 52, a base plate 56 attached to a bottom surface of the casing 52 with the spring 54 therebetween, and an adjustable screw 58.

The casings 52 are fixed to the deck base 10 at four corners of the opening 12 to which ends of the main and sub shafts 14 and 16 are disposed. The casing 52 has an inner space open downward, and is provided at its side with a gate opening 52a into which an end of the main shaft or the sub shaft is inserted.

The casing 52 is further provided with a locking piece 52b which is laterally extended to be attached to the deck base 10 by means of a locking screw 56a.

The spring 54 is disposed between the casing 52 and the main shaft 14 or the sub shaft 16 to cause the shaft to be biased downwardly.

The base plate 56 is attached to the bottom surface of the casing 52 by means of the locking screw 56a to prevent the main shaft 14 or the sub shaft 16 from being separated from the casing 52.

The adjustable screw 58 is threadedly coupled to the base plate 56 to urge the main shaft 14 or the sub shaft 16 upward.

Operation and function of the apparatus according to the present invention will now be described.

Since the apparatus of the present invention allows a main shaft 14 and a sub shaft 16 to be moved upwardly and downwardly by adjusters 50 to which the main and sub shafts 14 and 16 are supported, an optical pickup 30, which is mounted on the main and sub shafts 14 and 16, can be freely adjusted in its tilt and height.

That is, when the parallelism of the optical pickup 30 is disturbed due to tilt deformation of an optical disc “D”, one or more of both ends of the main shaft 14 and both ends of the sub shaft 16 are adjusted in height by tightening and loosening one or more of the three adjustable screws 58, thereby achieving parallelism of the optical pickup 30.

Moreover, when deviation in a distance “d” between the optical pickup 30 and the optical disc “D” occurs due to an assembly error of the spindle motor 20 and the turntable 22, one or more of the adjustable screws 58 associated with ends of the main and sub shafts is tightened and loosened to control the height of the main and sub shafts 14 and 16 and thus the height of the optical pickup in height.

Since the apparatus according to the present invention is capable of maintaining the parallel position and certain distance “d” between the optical disc and the optical pickup at any time by controlling a tilt and height of the optical pickup 30, an error occurring in writing and/or reading of information can be minimized, and an optical system having excellent performance can be achieved.

Furthermore, since deviation in a distance between the optical disc and the optical pickup caused by misassembly due to forced fitting of the turntable to the spindle motor can be compensated by controlling the heights of ends of the main and sub shafts 14 and 16, the apparatus according to the present invention enables an optical disc having structure faults such as warping to be read, and design range of an optical system to be widened.

In addition, since it is possible to freely control a distance between the optical disc and the optical pickup even after assembly of the turntable and the spindle motor, time required for assembly of the apparatus is shortened, thus improving operation efficiency.

As described above, the present invention provides an apparatus for controlling an optical pickup which is capable of adjusting a tilt and a height of an optical pickup by means of adjusters. Therefore, a distance between an optical pickup and an optical disc can be maintained uniformly, and thus error occurring in reading from an optical disc can be remarkably reduced.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for controlling an optical pickup, comprising adjusters which are adapted to upwardly and downwardly move the each end of the main and sub shafts supported thereto to separately control heights of the ends from a deck base, an optical pickup being mounted at its opposite ends on the main and sub shafts, whereby the parallelism and a certain distance between the optical pickup and an optical disc can be maintained by controlling tilts and heights of the main and sub shafts.

2. The apparatus as set forth in claim 1, in which each of the adjusters comprises:
a casing fixed to a deck base next to four corners of an opening formed at the deck base, and having an inner space open downwardly and a gate opening at its side, the inner space and the gate opening receiving an end of the main shaft or the sub shaft;
a spring disposed between the casing and the end of the main shaft or the sub shaft to bias the end downward;
a base plate attached to a lower surface of the casing to prevent the main shaft or the sub shaft from being separated; and
an adjustable screw tightened to the base plate to move the end of the main and sub shafts upward.

3. An optical writing and reading apparatus, comprising:
a deck base having an opening;
a turntable mounted on the deck base and adapted to be rotated by a spindle motor;
a main shaft and a sub shaft disposed to both sides of the opening and being parallel to each other;
adjusters attached to the deck base to support the each end of the main and sub shafts and to move the ends upwardly and downwardly; and
an optical pickup mounted at its opposite ends on the main and sub shaft and capable of moving along the main and sub shafts.

4. The optical writing and reading apparatus as set forth in claim 3, in which each of the adjusters comprises:
a casing fixed to a deck base next to four corners of an opening formed at the deck base, and having an inner space open downwardly and a gate opening at its side, the inner space and the gate opening receiving an end of the main shaft or the sub shaft;
a spring disposed between the casing and the end of the main shaft or the sub shaft to bias the end downward;
a base plate attached to a lower surface of the casing to prevent the main shaft or the sub shaft from being separated; and
an adjustable screw tightened to the base plate to move the end of the main and sub shafts upward.
